(19) United States
(12) Patent Application Publication
(10) Pub. No.: US 2026/0004949 A1
(43) Pub. Date: Jan. 1, 2026

(54) MULTICORE CABLE

(71) Applicant: Proterial, Ltd., Tokyo (JP)

(72) Inventors: Hiroshi YAMADA, Tokyo (JP); Tomoyuki MURAYAMA, Tokyo (JP)

(21) Appl. No.: 19/233,859

(22) Filed: Jun. 10, 2025

(30) Foreign Application Priority Data
Jun. 28, 2024 (JP) 2024-104777

(51) Int. Cl. H01B 7/18

(52) U.S. Cl. CPC H01B 7/1805

(57) ABSTRACT

A multicore cable includes a holding body compose of a first tubular portion and a second tubular portion connected by a connecting portion in such a manner that the first tubular portion and the second tubular portion are parallel to each other, a plurality of first insulated wires held by the first tubular portion, and a plurality of second insulated wires held by the second tubular portion, wherein the connecting portion includes a plurality of connecting pieces arranged along a longitudinal direction of the first tubular portion and the second tubular portion, and wherein each of the plurality of connecting pieces is interposed between the first tubular portion and the second tubular portion to connect the first tubular portion and the second tubular portion.

### CROSS-REFERENCE TO RELATED APPLICATIONS

The present patent application claims the priority of Japanese patent application No. 2024-104777 filed on Jun. 28, 2024, the entire contents of which are incorporated herein by reference.

### TECHNICAL FIELD

This invention relates to a multicore cable having a plurality of wires.

### BACKGROUND OF THE INVENTION

Conventional multicore cables having a plurality of wires are known, for example, as described in Patent Literature 1. The multicore cable described in Patent Literature 1 has a plurality of power lines, a plurality of signal lines, a binder winding made of resin tape covering the plurality of power lines and the plurality of signal lines, and an outer coating (i.e., jacket) made of thermoplastic resin such as plasticized polyurethane. The plurality of power lines are used, for example, to supply operating power to an electric parking brake of a vehicle. The plurality of signal lines are used, for example, to connect a wheel speed sensor.

In the first and second embodiments shown in FIGS. 1 and 2 of Patent Literature 1, the plurality of power lines and the plurality of signal lines are twisted together as a single unit (i.e., one piece), and the binder winding and the jacket are provided around the outer circumference of the plurality of power lines and the plurality of signal lines twisted together. In the third embodiment shown in FIG. 3, the plurality of power lines and the plurality of signal lines are arranged in parallel in a row to form a flat multicore cable with a flat shape.

### CITATION LIST

Patent Literature 1: JP2018-32515A

### SUMMARY OF THE INVENTION

As in the first and second embodiments of Patent Literature 1, in a configuration in which a plurality of power lines and a plurality of signal lines are twisted together, the cable outer diameter becomes larger and the plurality of power lines and the plurality of signal lines rub against each other when the cable is bent, which may cause a decrease in bending durability. In addition, when the plurality of power lines and the plurality of signal lines are arranged in parallel in a row, as in the third embodiment of the Patent Literature 1, the cable can flexibly bend in a direction perpendicular to the alignment direction of the plurality of power lines and the plurality of signal lines, but it becomes difficult to bend in a direction parallel to the alignment direction. Therefore, the object of the present invention is to provide a multicore cable that can be downsized and has enhanced flexibility.

For the purpose of solving the above problem, one aspect of the present invention provides a multicore cable, comprising:
a holding body comprising a first tubular portion and a second tubular portion connected by a connecting portion in such a manner that the first tubular portion and the second tubular portion are parallel to each other;
a plurality of first insulated wires held by the first tubular portion; and
a plurality of second insulated wires held by the second tubular portion,
wherein the connecting portion comprises a plurality of connecting pieces arranged along a longitudinal direction of the first tubular portion and the second tubular portion, and
wherein each of the plurality of connecting pieces is interposed between the first tubular portion and the second tubular portion to connect the first tubular portion and the second tubular portion.

### Advantageous Effects of the Invention

According to the present invention, it is possible to provide a multicore cable that can be downsized and has enhanced flexibility.

### BRIEF DESCRIPTION OF THE DRAWINGS

FIGS. 1A and 1B are external views of a multicore cable in the first embodiment of the present invention.

FIG. 2 is an explanatory diagram showing one end of the multicore cable stripped in steps.

FIG. 3 is a cross-sectional view of the multicore cable taken along line A-A in FIG. 1A.

FIG. 4 is a perspective cross-sectional view of the multicore cable.

FIG. 5 is an enlarged view of one of a plurality of connecting pieces.

FIG. 6 is a perspective view of an extrusion molded body.

FIG. 7 is an explanatory diagram showing an example of the use of the multicore cable installed in a vehicle.

FIG. 8A is a cross-sectional view of a multicore cable in a Comparative example 1.

FIGS. 8B and 8C are cross-sectional views of the multicore cable in the first embodiment shown for comparison with the multicore cable in Comparative example 1.

FIG. 9A is a configuration diagram of a multicore cable in Comparative example 2 in a partially bent state.

FIG. 9B is a cross-sectional view of the multicore cable in Comparative example 2 taken along line B-B in FIG. 9A.

FIGS. 10A to 10D are configuration diagrams of multicore cables in modified examples 1 to 4 of the first embodiment.

FIG. 11A is an external view of a multicore cable in the second embodiment of the invention.

FIG. 11B is a partially enlarged view of FIG. 11A.

FIG. 12A is an external view of a multicore cable in the third embodiment of the invention.

FIG. 12B is a partially enlarged view of FIG. 12A.

### DETAILED DESCRIPTION OF THE INVENTION

### First Embodiment

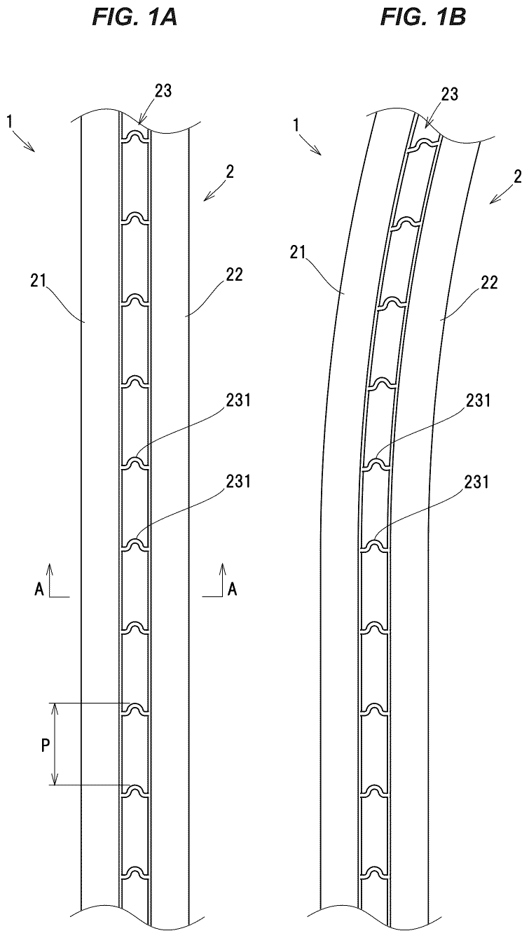

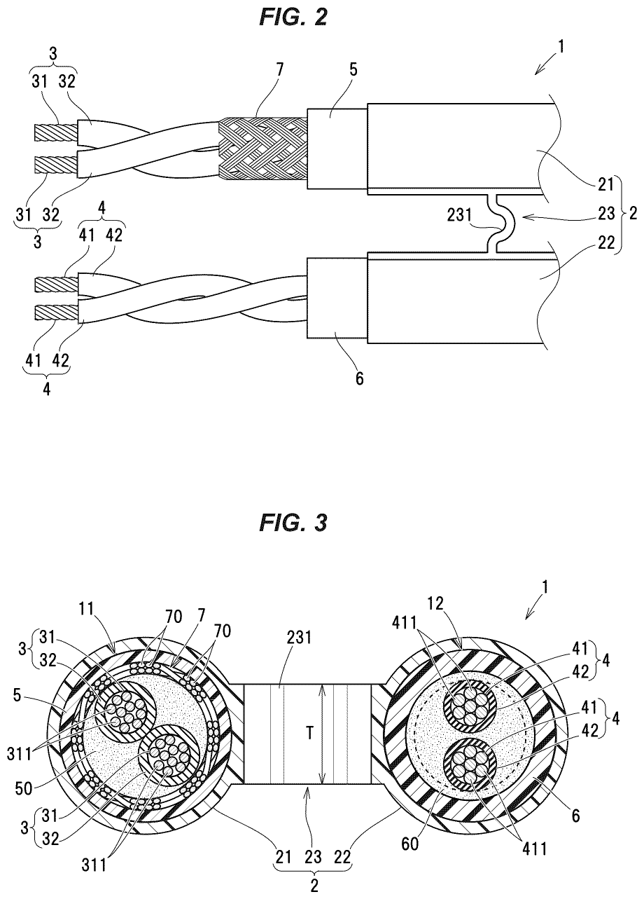

FIGS. 1A and 1B are external views of a multicore cable 1 in the first embodiment of the invention. FIG. 1A shows the multicore cable 1 in a straight line, and FIG. 1B shows a portion of the multicore cable 1 bent in a width direction. FIG. 2 shows the state in which one end of the multicore cable 1 stripped in steps. FIG. 3 is a cross-sectional view of the multicore cable 1 taken along line A-A in FIG. 1A.

The multicore cable 1 has a holding body (i.e., retaining body) 2 composed of flexible resin, a plurality of first insulated wires 3 and a plurality of second insulated wires 4 held in the holding body 2, a first sheath 5 covering the plurality of first insulated wires 3, a second sheath 6 covering the plurality of second insulated wires 4, a shield conductor 7 that covers the plurality of first insulated wires 3 inside the first sheath 5.

The first sheath 5 and its contents, i.e., the plurality of first insulated wires 3 and the shield conductor 7, constitute a first cable portion 11. The second sheath 6 and its contents, the plurality of second insulated wires 4, constitute a second cable portion 12. In the present embodiment, the plurality of first insulated wires 3 are power lines that supply operating power to a supply target, and the plurality of second insulated wires 4 are signal lines that transmit electrical signals. The plurality of first insulated wires 3 are twisted together in the first sheath 5. The plurality of second insulated wires 4 are twisted together in the second sheath 6.

The first insulated wire 3 has a core wire 31 composed of a conductor and an insulating coating 32 covering the core wire 31. Similarly, the second insulated wire 4 has a core wire 41 composed of a conductor and an insulating coating 42 covering the core wire 41. The core wires 31, 41 are stranded wires respectively composed of a plurality of conductor wire strands 311, 411 made of, e.g., copper, copper alloy, aluminum, or aluminum alloy. The insulating coatings 32, 42 are composed of thermoplastic resin, such as polyvinyl chloride, polyethylene, fluoropolymer or polyester.

As shown in FIG. 3, in the present embodiment, two first insulated wires 3 are twisted together within the first sheath 5, but three or more first insulated wires 3 may be twisted together within the first sheath 5. Also, in the present embodiment, two second insulated wires 4 are twisted together within the second sheath 6, but three or more second insulated wires 4 may be twisted together within the second sheath 6. The direction of twisting of the plurality of first insulated wires 3 and the direction of twisting of the plurality of second insulated wires 4 may be the same or different.

Fillers 50, 60 are disposed on outer circumferences of the plurality of first insulated wires 3 in the first sheath 5 and the plurality of second insulated wires 4 in the second sheath 6, respectively. As the fillers 50, 60, various fibrous materials can be used, such as polypropylene yarn, aramid fiber, nylon fiber, or fiber-based plastics.

In the present embodiment, the shield conductor 7 is a braided wire consisting of a plurality of shield strands 70 braided together in a grid pattern to suppress electromagnetic waves radiated outside the first sheath 5 by the current flowing in the first insulated wire 3. However, the configuration of the shield conductor 7 is not limited to braided wires; for example, the shield conductor 7 may be configured by a plurality of shield strands or conductive tapes arranged in a spiral shape.

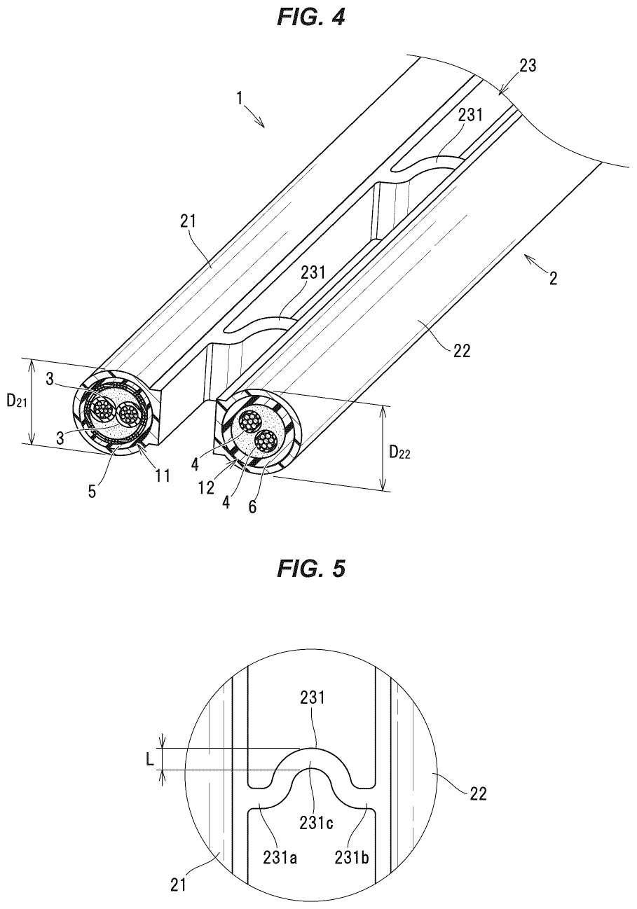

FIG. 4 is a perspective cross-sectional view of the multicore cable 1. FIG. 4 shows a diagrammatic cross-sectional view of the multicore cable 1. The holding body 2 of the multicore cable 1 integrally comprises a first tubular portion (i.e., first linear portion) 21 holding the first cable portion 11, a second tubular portion (i.e., second linear portion) 22 holding the second cable portion 12, and a connecting portion 23 connecting the first tubular portion 21 and the second tubular portion 22. The holding body 2 is made of thermoplastic resin, and the first tubular portion 21, the second tubular portion 22, and the connecting portion 23 are each flexible. The connecting portion 23 connects the first tubular portion 21 and the second tubular portion 22 so that the first tubular portion 21 and the second tubular portion 22 are parallel to each other.

The first tubular portion 21 and the second tubular portion 22 are each tubular and extend parallel to each other at a predetermined distance. The plurality of first insulated wires 3 are held in the first tubular portion 21 and the plurality of second insulated wires 4 are held in the second tubular portion 22. The connecting portion 23 comprises a plurality of connecting pieces 231 arranged along a longitudinal direction of the first tubular portion 21 and the second tubular portion 22. The plurality of connecting pieces 231 are interposed respectively between the first tubular portion 21 and the second tubular portion 22 to connect the first tubular portion 21 and the second tubular portion 22.

FIG. 5 is an enlarged view of one of the plurality of connecting pieces 231. In FIG. 5, the connecting piece 231 is shown viewed from a direction perpendicular to the longitudinal and alignment directions of the first tubular portion 21 and the second tubular portion 22. The connecting piece 231 is curved so that a central portion between the first tubular portion 21 and the second tubular portion 22 is convex toward one side along the longitudinal direction of the first tubular portion 21 and the second tubular portion 22.

More specifically, the connecting piece 231 comprises a first straight portion 231a extending from a first tubular portion 21-side toward the second tubular portion 22, a second straight portion 231b extending from a second tubular portion 22-side toward the first tubular portion 21, and a curved portion 231c between an end of the second tubular portion 22-side in the first straight portion 231a and an end of the first tubular portion 21-side in the second straight portion 231b. The second straight portion 231b extends from the second tubular portion 22-side toward the first tubular portion 21.

The shape of curved portion 231c viewed from a direction perpendicular to the longitudinal and alignment directions of first tubular portion 21 and second tubular portion 22 is arc-shaped. The shape of the first straight portion 231a and the second straight portion 231b viewed from the same direction is a straight line along the alignment direction of the first tubular portion 21 and the second tubular portion 22. The shape of the curved portion 231c viewed from the same direction in a natural state in which no external force is applied to the holding body 2 is a semicircle shape as shown in FIG. 5.

The convex shape of the curved portion 231c contributes to improving the bendability of the multicore cable 1 by flexibly deforming the connecting pieces 231 between the first tubular portion 21 and the second tubular portion 22 when the multicore cable 1 is bent. That is, for example, when the multicore cable 1 is bent as shown in FIG. 1B, a force acts on the first tubular portion 21 such that the side opposite the second tubular portion 22 is stretched and the second tubular portion 22 is compressed, while in the second tubular portion 22, the first tubular portion 21 is stretched and the first tubular portion 21 is stretched. The plurality of connecting pieces 231 interposed between the first tubular portion 21 and the second tubular portion 22 absorb such differences in bending behavior of the first tubular portion 21 and the second tubular portion 22 and relieve stress on the plurality of first insulated wires 3 held in the first tubular portion 21 and the plurality of second insulated wires 4 held in the second tubular portion 22. This enhances the bending durability of the multicore cable 1.

The holding body 2 is formed by extrusion molding using an extruder. In manufacturing the multicore cable 1, the first cable portion 11 and the second cable portion 12 that are pre-formed are introduced into the extruder, and molten resin melted by heat is supplied around the first cable portion 11 and second cable portion 12 and between the first cable portion 11 and second cable portion 12. The molten resin solidifies to form an extrusion molded body (i.e., extrudate) that will become the holding body 2.

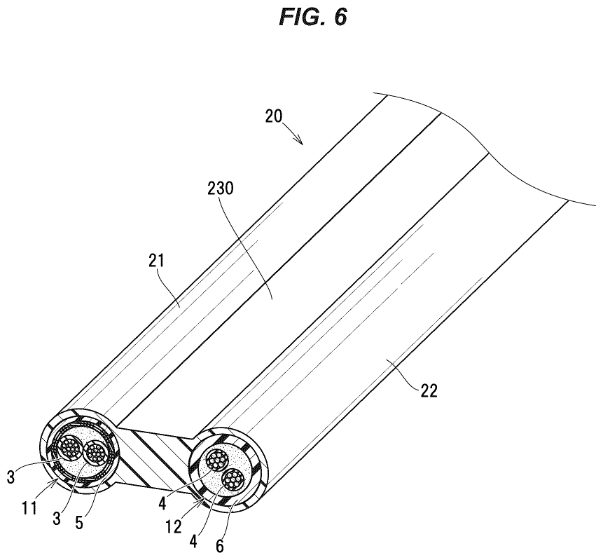

FIG. 6 is a perspective view of the extrusion molded body 20. The extrusion molded body 20 has the first tubular portion 21 holding the first cable portion 11 and the second tubular portion 22 holding the second cable portion 12, and the first tubular portion 21 and the second tubular portion 22 are connected by a flat strip-shaped connecting plate portion 230. By pressing and punching this connecting plate portion 230 at predetermined intervals, a connecting portion 23 comprising a plurality of connecting pieces 231 is formed. In other words, the plurality of connecting pieces 231 are the portions that remain after the connecting plate portions 230 are not punched out in the pressing process. The pressing of the connecting plate portion 230 may be performed continuously with the forming of the extrusion molded body 20 by placing the press working machine alongside the extruder, or it may be performed after the extrusion molded body 20 is once wound onto a take-up member such as a drum and then the extrusion molded body 20 is pulled out from this take-up member.

In the present embodiment, the connecting portion 23 was formed by press punching, but a die may also be used to form the connecting portion 23. For example, the first tubular portion 21 and the second tubular portion 22 formed separately may be set in a die, and material may be extruded between the first tubular portion 21 and the second tubular portion 22 to form the connecting portion 23 comprising a plurality of connecting pieces 231 that connect the first tubular portion 21 and the second tubular portion 22.

In this embodiment, the first sheath 5 and second sheath 6 are made of the same type of resin as the holding body 2, and the first sheath 5 and second sheath 6 and the holding body 2 are welded together by heat during extrusion molding of the extrusion molded body 20. This allows the first sheath 5 and first tubular portion 21 and the second sheath 6 and second tubular portion 22 to be removed as one piece, respectively, during terminal processing to attach a connector or the like to the end of the multicore cable 1, thereby facilitating terminal processing. Resin materials such as polyurethane, for example, can be suitably used for the holding body 2, first sheath 5, and second sheath 6.

The resin material of the first sheath 5 and the second sheath 6 may be made of a different resin material than that of the holding body 2, so that the first sheath 5 and the second sheath 6 and the holding body 2 are not welded together by heat during extrusion of the extrusion molded body 20. In this case, the resin material of the first sheath 5 and the second sheath 6 can be, for example, olefin resin such as cross-linked polyethylene, polypropylene, or vinyl chloride, and the resin material of the holding body 2 can be, for example, polyurethane or rubber. The fact that the first sheath 5 and the second sheath 6 and the holding body 2 are not welded together enhances the bending durability of the multicore cable 1 by causing slippage between the outer circumference of the first sheath 5 and the inner circumference of the first tubular portion 21 and between the outer circumference of the second sheath 6 and the inner circumference of the second tubular portion 22, when the cable 1 is flexed.

Although there are no particular limitations on the dimensions, etc. of the various parts of the multicore cable 1, the thickness T of the connecting piece 231 (see FIG. 3) in the direction perpendicular to the alignment direction of the first tubular portion 21 and the second tubular portion 22 (see FIG. 4) may be, for example, between 0.2 and 1.0 times the outer diameter D21 of the first tubular portion 21 and D22 of the second tubular portion 22 (see FIG. 4) may be 0.2 to 1.0 times or more than 0.2 times the outer diameter of the first tubular portion 21 and the second tubular portion 22. The length L of the connecting piece 231 (see FIG. 5) in the longitudinal direction of the first tubular portion 21 and the second tubular portion 22 may be, e.g., between 0.2 and 1.0 times the thickness T of the connecting piece 231. The pitch P of the connecting piece 231 (see FIG. 1) may be, e.g., between 0.5 and 10 times the thickness T of the connecting piece 231. The pitch interval of the connecting pieces 231 may be adjusted by cutting a part of the connecting piece 231 to match the layout in which the multicore cable 1 is arranged. In this case, the pitch intervals may be equally or unequally spaced.

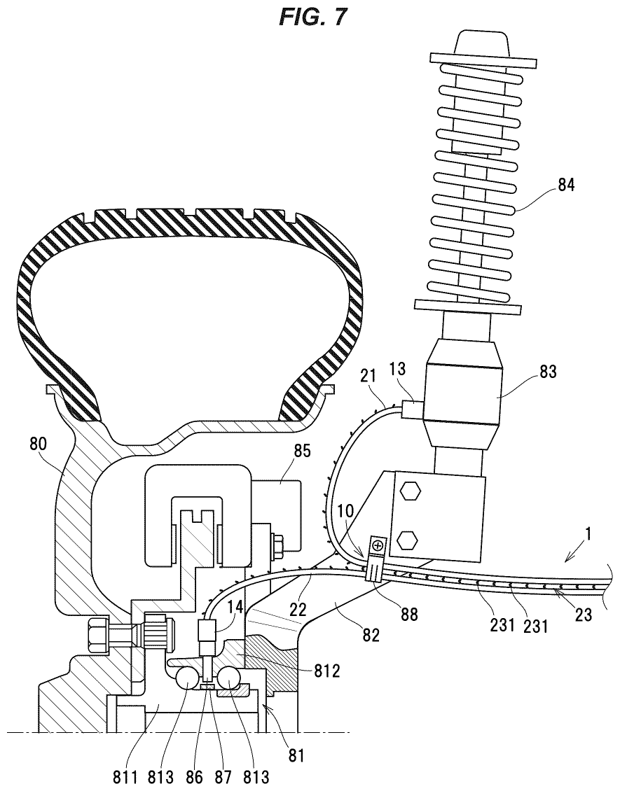

FIG. 7 is an explanatory diagram showing an example of the use of the multicore cable 1 in a vehicle. The vertical direction in FIG. 7 corresponds to the vertical up and down of the vehicle. In FIG. 7, a wheel 80, a hub unit 81 that rotatably supports the wheel 80, a knuckle 82 of the suspension system to which the hub unit 81 is attached, a variable damping force damper 83 connected to the knuckle 82, a suspension spring 84 located around the outer circumference of the variable damping force damper 83, an electric parking brake device 85, and a wheel speed sensor 86 that detects the rotational speed of the wheel 80. The hub unit 81 has a hub wheel 811 rotating in unison with the wheel 80, an outer wheel 812 fixed to the knuckle 82, and a plurality of rolling elements 813 disposed between the hub wheel 811 and the outer wheel 812. The wheel 80 is, as an example, the front wheel, which is the steering wheel of the vehicle, and the multicore cable 1 is twisted in various directions according to the steering angle of the wheel 80.

An annular magnetic encoder 87 with a plurality of magnetic poles along the circumferential direction is fixed to the hub wheel 811, opposite the wheel speed sensor 86. The wheel speed sensor 86 is fixed to the outer wheel 812 and detects the rotational speed of the wheel 80 by rotation of the magnetic encoder 87.

In the example shown in FIG. 7, the first connector 13 on one end of the plurality of first insulated wires 3 of the first cable portion 11 is attached to the variable damping force damper 83, and the second connector 14 on one end of the plurality of second insulated wires 4 of the second cable portion 12 is attached to the wheel speed sensor 86. The other end of the plurality of first insulated wires 3 is connected to a damping force control device that controls the damping force of the variable damping force dampers 83 according to the running condition of the vehicle. The other end of the plurality of second insulated wires 4 is connected to a brake control device that controls the braking force acting on the wheel 80 to suppress locking of the wheel 80. The plurality of first insulated wires 3 supply operating power to the variable damping force damper 83, which is the supply target. The plurality of second insulated wires 4 transmit the detection signal of the wheel speed sensor 86 to the brake control device.

The plurality of first insulated wires 3 may be connected to the electric parking brake device 85 and used to supply operating power to the electric parking brake device 85. The plurality of second insulated wires 4 may be connected to the electric parking brake device 85 and used to transmit signals related to the control of the electric parking brake device 85.

The multicore cable 1 is supported by a support fitting 88 fixed to the knuckle 82, for example, and is repeatedly bent as the wheel 80 moves up and down or is steered against the body of the vehicle as the vehicle runs. The multicore cable 1 is separated from the first tubular portion 21 and the second tubular portion 22 in the vicinity of the support fitting 88, with the first tubular portion 21 facing the connection target of the plurality of first insulated wires 3 (variable damping force damper 83 in the example of FIG. 7) together with the first cable portion 11, and the second tubular portion 22 facing the connection target of the plurality of second insulated wires 4 (the second cable portion 12) together with the second cable portion 12. facing the connection target of the insulated wires 4 (wheel speed sensor 86 in the example of FIG. 7). In the longitudinal direction of the multicore cable 1, the plurality of connecting pieces 231 are cut off at the part where the first tubular portion 21 and the second tubular portion 22 are separated.

Thus, the multicore cable 1 can be arranged as a single cable up to a branching point 10 between the first tubular portion 21 and the second tubular portion 22, although the first tubular portion 21 and the second tubular portion 22 are separated in a part of the longitudinal direction, which improves the arrangement compared to, for example, connecting individual cables to the variable damping force damper 83 and wheel speed sensor 86, respectively. This improves the ease of layout compared to, for example, connecting individual cables to the variable damping force damper 83 and wheel speed sensor 86, respectively. The multicore cable 1 should be supported by a support object (knuckle 82 in the example shown in FIG. 7) in the vicinity of the branching point 10 of the first tubular portion 21 and the second tubular portion 22.

### Comparative Example 1

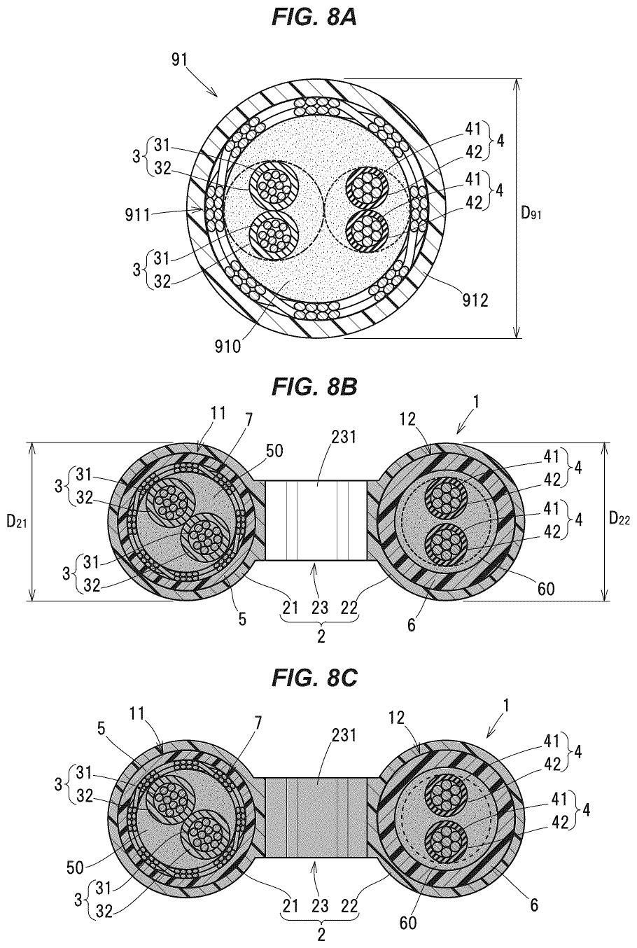

FIG. 8A is a cross-sectional view of a multicore cable 91 in Comparative example 1. FIGS. 8B and 8C are cross-sectional views of the multicore cable 1 according to the first embodiment shown for comparison with the multicore cable 91 in Comparative example 1. The multicore cable 91 has a plurality of first insulated wires 3 and a plurality of second insulated wires 4 as in the multicore cable 1 of the first embodiment, but the plurality of first insulated wires 3 and the plurality of second insulated wires 4 are collectively covered with a shield conductor 911 and the outer circumference of the shield conductor 911 is covered by the sheath 912. The plurality of first insulated wires 3 and the plurality of second insulated wires 4 are twisted together. Fillers 910 are disposed around the plurality of first insulated wires 3 and the plurality of second insulated wires 4.

Let D₉₁ be the outer diameter of the multicore cable 91 and D₂₁ and D₂₂ be the outer diameters of the first tubular portion 21 and the second tubular portion 22, respectively, of the multicore cable 1, D₂₁ and D₂₂ are about 60% of D₉₁. If the cross-sectional area of the multicore cable 91 is S₉₁(=(D₉₁/2)\hat{ }2×3.14), and if the cross-sectional area of the multicore cable 1 (cross-sectional area of the first tubular portion 21 and first cable portion 11 and the second tubular portion 22 and second cable portion 12 of the multicore cable 1) in the area shaded in FIG. 8B is S₁₁, S₁₁ is about 73% of S₉₁. Furthermore, as shown in FIG. 8C, if S₁₂ is the area of the multicore cable 1 including S₁₁ plus the area of the connecting piece 231 viewed from the longitudinal direction of the multicore cable 1, S₁ and S₂ are about 88% of S₉₁.

Thus, the multicore cable 1 in the first embodiment is smaller than the multicore cable 91 according to the comparative example 1. In addition, the multicore cable 1 in the first embodiment is flexible and bendable because the outer diameters D₂₁, D₂₂ of the first tubular portion 21 and the second tubular portion 22, respectively, are smaller than the outer diameter D₉₁ of the multicore cable 91. Furthermore, since the multicore cable 1 can reduce the amount of the fillers 50, 60 compared to the amount of the fillers 910 in the multicore cable 91 in Comparative example 1, the terminal processing is easier.

### Comparative Example 2

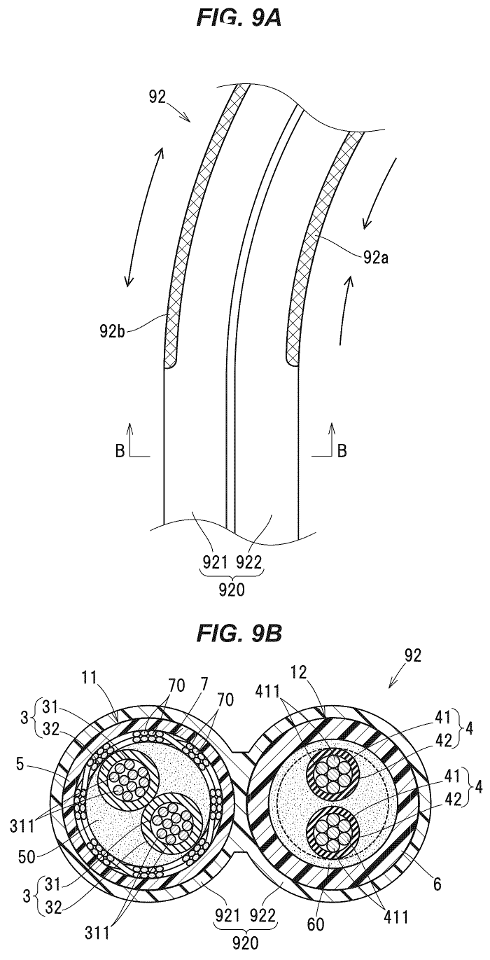

FIG. 9A is a configuration diagram of a multicore cable 92 in Comparative example 2 in a partially bent state. FIG. 9B is a cross-sectional view taken along line B-B in FIG. 9A. The multicore cable 92 has the first cable portion 11 and the second cable portion 12 similar to the multicore cable 1 in the first embodiment, and the first cable portion 11 and the second cable portion 12 are held in a holding body 920, but the configuration of the holding body 920 is different from the holding body 2 in the first embodiment. The holding body 920 has a first tubular portion 921 that holds the first cable portion 11 and a second tubular portion 922 that holds the second cable portion 12, and the first tubular portion 921 and the second tubular portion 922 are directly connected and integrated. In other words, the holding body 920 of the multicore cable 92 does not have a portion corresponding to the connecting portion 23 in the holding body 2 of the multicore cable 1 of the first embodiment.

Thus, the multicore cable 92 in Comparative example 2 is not equipped with a portion corresponding to the connecting portion 23 of the holding body 2 that functions as a buffer to absorb the difference in bending behavior of the first tubular portion 921 and the second tubular portion 922, so that when the multicore cable 92 is bent toward the second tubular portion 922, as shown in FIG. 9A, for example, when the multicore cable 92 is bent toward the second tubular portion 922 as shown in FIG. 9A, the second tubular portion 922 is compressed in an inner portion 92a, which is inside the bend, and the first tubular portion 921 is stretched in an outer portion 92b, which is outside the bend. The compression of the inner portion 92a involves the force that the second tubular portion 922 receives from the first tubular portion 921, and the stretching of the outer portion 92b involves the force that the first tubular portion 921 receives from the second tubular portion 922.

In contrast, in the multicore cable 1 in the first embodiment, the first tubular portion 21 and the second tubular portion 22 of the holding body 2 are connected by the plurality of flexible connecting pieces 231, so that the first tubular portion 21 and the second tubular portion 22 are less susceptible to each other, and each is easier to bend independently, For example, even when the cable is bent as shown in FIG. 1B, it is suppressed that the first tubular portion 21 and the second tubular portion 22 are greatly compressed or elongated. This enhances the flexibility of the multicore cable 1 and improves the bending durability.

### Modified Examples of the First Embodiment

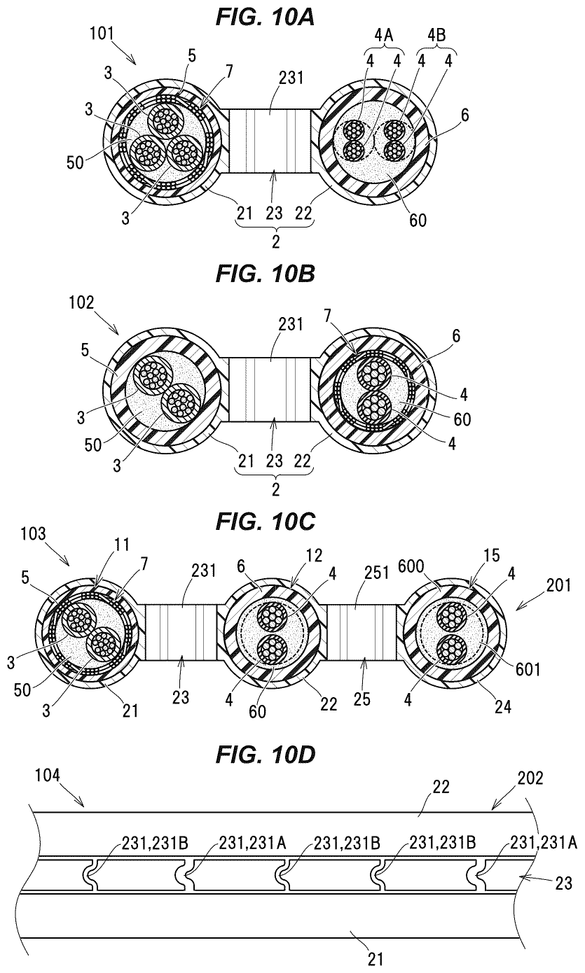

FIGS. 10A to 10C are cross-sectional views of multicore cables 101 to 103 in a cross-section perpendicular to the longitudinal direction in modified examples 1 to 3 of the first embodiment. FIG. 10D is an external view of a multicore cable 104 in modified example 4 of the first embodiment.

### Modified Example 1

In the multicore cable 101 in modified example 1 shown in FIG. 10A, three first insulated wires 3 are held in the first tubular portion 21 of the holding body 2 and four second insulated wires 4 are held in the second tubular portion 22. The three first insulated wires 3 are used, for example, when the electric parking brake device 85 shown in FIG. 7 has a three-phase AC The three first insulated wires 3 can be used to supply three-phase AC current to the three-phase AC motor when the electric parking brake device 85 shown in FIG. 7 has a three-phase AC motor as a drive source. It can also be used to supply three-phase AC current to the three-phase AC motor when the electric brake for decelerating and stopping the vehicle has a three-phase AC motor as the drive source.

Of the four second insulated wires 4, two second insulated wires 4 are pair-twisted to form a twisted pair wire 4A, and the other two second insulated wires 4 are pair-twisted to form a twisted pair wire 4B. This allows the twisted pair wires 4A and 4B to be connected to different connection targets (e.g., wheel speed sensor 86 and electric parking brake device 85 shown in FIG. 7) and used to transmit separate electrical signals, respectively.

### Modified Example 2

In the multicore cable 102 in modified example 2 shown in FIG. 10B, the two first insulated wires 3 are not covered by the shield conductor 7, and the two second insulated wires 4 are covered by the shield conductor 7 in the second sheath 6. This configuration also suppresses the electromagnetic waves radiated outside the first sheath 5 by the current flowing in the plurality of first insulated wires 3 from affecting the electrical signals transmitted by the plurality of second insulated wires 4.

### Modified Example 3

In the multicore cable 103 in modified example 3 shown in FIG. 10C, the holding body 201 made of flexible resin has, in addition to the first tubular portion 21, the second tubular portion 22, and the connecting portion 23 similar to the multicore cable 1 in the first embodiment, a third tubular portion 24 and a connecting portion 25 that connects the third tubular portion 24 and the second tubular portion 22. The third tubular portion 24 holds the third cable portion 15 with, as an example, two second insulated wires 4 and a filler 601 housed in a third sheath 600. The connecting portion 25 is constructed in the same manner as the connecting portion 23 connecting the first tubular portion 21 and the second tubular portion 22, and has a plurality of connecting pieces 251 interposed between the third tubular portion 24 and the second tubular portion 22. FIG. 10C shows one of these connecting pieces 251.

In this multicore cable 103, the first tubular portion 21 and the second tubular portion 22 are connected by the connecting portion 23 having the plurality of connecting pieces 231, and the second tubular portion 22 and the third tubular portion 24 are connected by the connecting portion 25 having the plurality of connecting pieces 251. The flexibility and bending durability are enhanced.

### Modified Example 4

The multicore cable 104 in modified example 4 shown in FIG. 10D is similar to the multicore cable 1 in the first embodiment, in which the first tubular portion 21 and the second tubular portion 22 of the holding body 202 are connected by the connecting portion 23 with the plurality of connecting pieces 231, but the thicknesses of the plurality of connecting pieces 231 are not uniform, and the connecting portion 23 has thick connecting pieces 231A, each of which is relatively thick in the longitudinal direction of the first tubular portion 21 and the second tubular portion 22, and thin connecting pieces 231B, each of which is relatively thin in the longitudinal direction of the first tubular portion 21 and the second tubular portion 22. In the example shown in FIG. 10D, the ratio of the number of thick connecting pieces 231A to the number of thin connecting pieces 231B is 1:2, but this ratio may be changed as needed.

### Second Embodiment

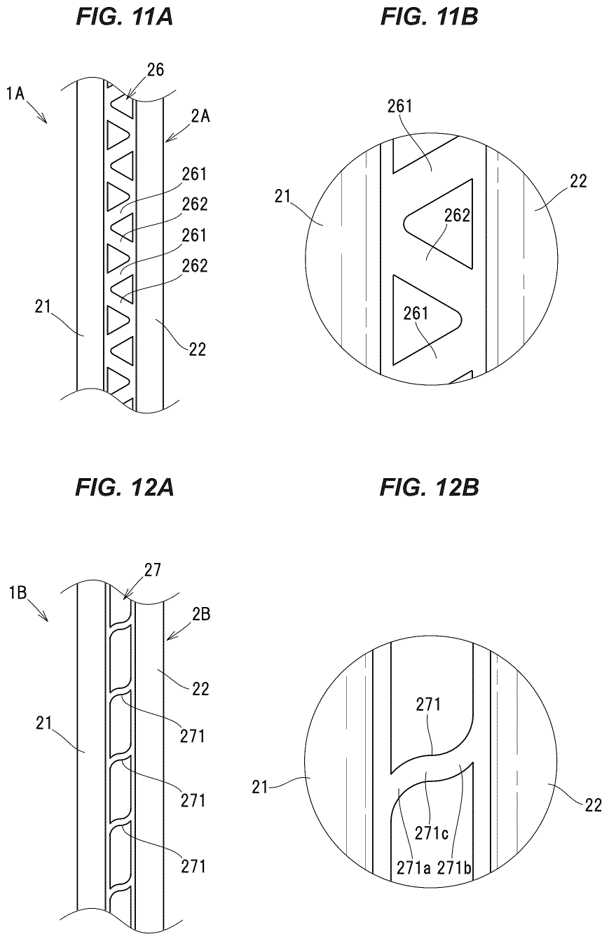

FIG. 11A is an external view of a multicore cable 1A in the second embodiment of the invention. FIG. 11B is a partially enlarged view of FIG. 11A. Like the multicore cable 1 in the first embodiment, the multicore cable 1A has a holding body 2A having a first tubular portion 21 and a second tubular portion 22, and the first tubular portion 21 and the second tubular portion 22 are connected by a connecting portion 26, but the configuration of the connecting portion 26 is different from the connecting portion 23 in the first embodiment. The first tubular portion 21 and the second tubular portion 22 of the multicore cable 1A hold the first cable portion 11 and the second cable portion 12, respectively, as in the multicore cable 1 in the first embodiment.

The connecting portion 26 of the multicore cable 1A includes, as a plurality of connecting pieces interposed between the first tubular portion 21 and the second tubular portion 22, a plurality of first inclined connecting pieces 261 inclined on one side with respect to the longitudinal direction of the first tubular portion 21 and the second tubular portion 22, and a plurality of second inclined connecting pieces 262 inclined on the other side with respect to the longitudinal direction of the first tubular portion 21 and the second tubular portion 22. The plurality of first inclined connecting pieces 261 and the plurality of second inclined connecting pieces 262 are arranged alternately in the longitudinal direction of the first tubular portion 21 and the second tubular portion 22.

In the examples shown in FIGS. 11A and 11B, the plurality of first inclined connecting pieces 261 and the plurality of second inclined connecting pieces 262 are continuous at the respective ends of the first tubular portion 21 and the second tubular portion 22 and present a zigzag shape as a whole, but the plurality of first inclined connecting pieces 261 and the plurality of second inclined connecting pieces 262 may be spaced apart in the longitudinal direction of the first tubular portion 21 and the second tubular portion 22. The plurality of first inclined connecting pieces 261 and the plurality of second inclined connecting pieces 262 may be crossed in an X-shaped configuration.

This second embodiment also provides the same effects as the first embodiment. The modified examples 1 to 4 described with reference to FIGS. 10A to 10D may be applied to the multicore cable 1A in the second embodiment.

### Third Embodiment

FIG. 12A is an external view of a multicore cable 1B in the third embodiment of the invention. FIG. 12B is a partially enlarged view of FIG. 12A. In the multicore cable 1B, as in the multicore cable 1 in the first embodiment, a holding body 2B has a first tubular portion 21 and a second tubular portion 22, and the first tubular portion 21 and the second tubular portion 22 are connected by a connecting portion 27, but the configuration of the connecting portion 27 is different from the connecting portion 23 in the first embodiment. The first tubular portion 21 and the second tubular portion 22 of the multicore cable 1B hold the first cable portion 11 and the second cable portion 12, respectively, as in the multicore cable 1 in the first embodiment.

The connecting portion 27 of the multicore cable 1B has a plurality of connecting pieces 271 interposed between the first tubular portion 21 and the second tubular portion 22. Each of the plurality of connecting pieces 271 is inclined to one side with respect to the longitudinal direction of the first tubular portion 21 and the second tubular portion 22 in the vicinity of the first tubular portion 21 and the second tubular portion 22, and is curved in such a manner that the inclination with respect to the alignment direction of the first tubular portion 21 and the second tubular portion 22 becomes gradual in a central portion between the first tubular portion 21 and the second tubular portion 22.

More specifically, each connecting piece 271 has a first inclined portion 271a inclined to one side of the longitudinal direction of the first tubular portion 21 at an end of the first tubular portion 21, a second inclined portion 271b inclined to one side of the longitudinal direction of the second tubular portion 22 at an end of the second tubular portion 22, and a middle portion 271c between the first inclined portion 271a and the second inclined portion 271b. The middle portion 271c has a gradual inclination with respect to the alignment direction of the first tubular portion 21 and the second tubular portion 22. In the examples shown in FIGS. 12A and 12B, the middle portion 271c extends parallel to the alignment direction of the first tubular portion 21 and the second tubular portion 22 (i.e., perpendicular to the longitudinal direction of the first tubular portion 21 and the second tubular portion 22).

This third embodiment also provides the same effects as the first embodiment. The modified examples 1 to 4 described with reference to FIGS. 10A to 10D may also be applied to the multicore cable 1B in the third embodiment.

### Summary of Embodiments

Next, the technical concepts that can be grasped from the above-described embodiments will be described with the aid of the codes, etc. in the embodiments. However, each code in the following description does not limit the components in the scope of the claims to the parts, etc. specifically shown in the embodiment.

According to the first embodiment, a multicore cable 1, 1A, 1B, 101 to 104 includes a holding body 2, 2A, 2B, 201, 202 composed of a first tubular portion 21 and a second tubular portion 22 connected by a connecting portion 23, 25, 26, 27 in such a manner that the first tubular portion 21 and the second tubular portion 22 are parallel to each other, a plurality of first insulated wires 3 held by the first tubular portion 21, and a plurality of second insulated wires 4 held by the second tubular portion 22, wherein the connecting portion 23, 25, 26, 27 is composed of a plurality of connecting pieces 231, 271, 251, 261, 262, 271 arranged along a longitudinal direction of the first tubular portion 21 and the second tubular portion 22, and wherein each of the plurality of connecting pieces 231, 271, 251, 261, 262, 271 is interposed between the first tubular portion 21 and the second tubular portion 22 to connect the first tubular portion 21 and the second tubular portion 22.

According to the second feature, in the multicore cable 1, 1A, 1B, 101 to 104 as described by the first feature, the plurality of first insulated wires 3 are covered by a first sheath 5 and held by the first tubular portion 21 and the plurality of second insulated wires 4 are covered by a second sheath 6 and held by the second tubular portion 22.

According to the third feature, in the multicore cable 1, 1A, 1B, 101 to 104 as described by the second feature, the first sheath 5 and the second sheath 6 are made of the same material as the holding body 2, 2A, 2B, 201, 202, and the first sheath 5 and the second sheath 6 and the holding body 2, 2A, 2B, 201, 202 are welded.

According to the fourth feature, in the multicore cable 1, 1A, 1B, 101 to 104 as described by the second feature, the first sheath 5 and the second sheath 6 are made of different materials from the holding body 2, 2A, 2B, 201, 202, and the first sheath 5 and the second sheath 6 and the holding body 2, 2A, 2B, 201, 202 are not welded.

According the fifth feature, in the multicore cable 1, 1A, 1B, 101 to 104 as described by any one of the second to fourth features, the plurality of first insulated wires 3 are twisted together in the first sheath 5 and the plurality of second insulated wires 4 are twisted together in the second sheath 6.

According to the sixth feature, in the multicore cable 1, 101 to 104 as described by the first feature, each of the plurality of connecting pieces 231 is curved in such a manner that a central portion (curved portion 231c) between the first tubular portion 21 and the second tubular portion 22 is convex toward one side along the longitudinal direction.

According to the seven feature, in the multicore cable 1A as described by the first feature, each of the plurality of connecting pieces 261, 262 includes a plurality of first inclined connecting pieces 261 inclined to one side with respect to the longitudinal direction and a plurality of second inclined connecting pieces 262 inclined to the other side with respect to the longitudinal direction, the plurality of first inclined connecting pieces 261 and the plurality of second inclined connecting pieces 262 are arranged alternately in the longitudinal direction.

According to the eighth feature, in the multicore cable 1B as described by the first feature, each of the plurality of connecting pieces 271 is inclined to one side with respect to the longitudinal direction in the vicinity of the first tubular portion 21 and the second tubular portion 22, and is curved in such a manner that the inclination with respect to the alignment direction of the first tubular portion 21 and the second tubular portion 22 becomes gradual in a central portion (middle portion 271c) between the first tubular portion 21 and the second tubular portion 22.

According to the ninth feature, in the multicore cable 1, 1A, 1B, 101 to 104 as described by the first feature, the plurality of first insulated wires 3 are power lines that supply operating power to a supply target and the plurality of second insulated wires 4 are signal lines that transmit signals.

According to the tenth feature, in the multicore cable 1, 1A, 1B, 101 to 104 as described by the ninth feature, at least any of the plurality of first insulated wires 3 and the plurality of second insulated wires 4 is covered by a shield conductor 7.

The above description of the first to third embodiments of the invention and modified examples 1 to 4 of the first embodiment do not limit the invention as claimed in the claims. It should also be noted that not all of the combinations of features described in the embodiments and modified examples are essential to the means for solving the problems of the invention. In addition, the invention can be implemented by modifying it as appropriate to the extent that it does not depart from the intent of the invention, for example, it can be implemented by the following modifications.

In the first to third embodiments described above, the case in which the plurality of connecting pieces 231, 271 are provided at regular intervals in the longitudinal direction of the first tubular portion 21 and the second tubular portion 22 is described, but the invention is not limited thereto. The plurality of connecting pieces 231, 271 may be provided at unequal intervals in the longitudinal direction of the first tubular portion 21 and the second tubular portion 22. Further, the plurality of connecting pieces interposed between the first tubular portion 21 and the second tubular portion 22 may be provided in a straight line parallel to the alignment direction of the first tubular portion 21 and the second tubular portion 22.

In the first embodiment above, the use of multicore cable 1 was described for connecting under-spring (i.e., unsprung) and over-spring (i.e., sprung) of a vehicle as an example of use. However, the multicore cable of the present invention is not limited to use in vehicles, but can also be used for industrial machinery, facilities, or information equipment, for example.

In the first to third embodiments described above, the case is described where the plurality of first insulated wires 3 held in the first tubular portion 21 are power lines that supply operating power to the supply target and the plurality of second insulated wires 4 held in the second tubular portion 22 are signal lines that transmit electrical signals, but the present invention is not limited thereto. The plurality of first insulated wires 3 and the plurality of second insulated wires 4 may both be power lines, and may also both be signal lines. The power and signal lines may be mixed and held in the first tubular portion 21, and the power and signal lines may be mixed and held in the second tubular portion 22.

1. A multicore cable, comprising:
a holding body comprising a first tubular portion and a second tubular portion connected by a connecting portion in such a manner that the first tubular portion and the second tubular portion are parallel to each other;
a plurality of first insulated wires held by the first tubular portion; and
a plurality of second insulated wires held by the second tubular portion,
wherein the connecting portion comprises a plurality of connecting pieces arranged along a longitudinal direction of the first tubular portion and the second tubular portion, and
wherein each of the plurality of connecting pieces is interposed between the first tubular portion and the second tubular portion to connect the first tubular portion and the second tubular portion.

2. The multicore cable, according to claim 1, wherein the plurality of first insulated wires are covered by a first sheath and held by the first tubular portion, and wherein the plurality of second insulated wires are covered by a second sheath and held by the second tubular portion.

3. The multicore cable, according to claim 2, wherein the first sheath and the second sheath are made of a same material as the holding body, and wherein the first sheath and the second sheath and the holding body are welded.

4. The multicore cable, according to claim 2, wherein the first sheath and the second sheath are made of different materials from the holding body, and wherein the first sheath and the second sheath and the holding body are not welded.

5. The multicore cable, according to claim 2, wherein the plurality of first insulated wires are twisted together in the first sheath, and wherein the plurality of second insulated wires are twisted together in the second sheath.

6. The multicore cable, according to claim 1, wherein each of the plurality of connecting pieces is curved in such a manner that a central portion between the first tubular portion and the second tubular portion is convex toward one side along the longitudinal direction.

7. The multicore cable, according to claim 1, wherein each of the plurality of connecting pieces comprises a plurality of first inclined connecting pieces inclined to one side with respect to the longitudinal direction and a plurality of second inclined connecting pieces inclined to an other side with respect to the longitudinal direction, and wherein the plurality of first inclined connecting pieces and the plurality of second inclined connecting pieces are arranged alternately in the longitudinal direction.

8. The multicore cable, according to claim 1, wherein each of the plurality of connecting pieces is inclined to one side with respect to the longitudinal direction in vicinity of the first tubular portion and the second tubular portion and is curved in such a manner that an inclination with respect to an alignment direction of the first tubular portion and the second tubular portion becomes gradual in a central portion between the first tubular portion and the second tubular portion.

9. The multicore cable, according to claim 1, wherein the plurality of first insulated wires are power lines that supply operating power to a supply target, and wherein the plurality of second insulated wires are signal lines that transmit signals.

10. The multicore cable, according to claim 9, wherein at least any of the plurality of first insulated wires and the plurality of second insulated wires is covered by a shield conductor.
